(19) United States
(12) Patent Application Publication
(10) Pub. No.: US 2015/0031289 A1
(43) Pub. Date: Jan. 29, 2015

(54) AUTONOMOUS DISCOVERY AND CONTROL OF DEVICES VIA AN OVERLAY COMMUNICATION CHANNEL

(71) Applicants: Rajiv Agarwal, Menlo Park, CA (US); Hawk Yin Pang, San Jose, CA (US); Michael Edward Smith Luna, San Jose, CA (US)

(72) Inventors: Rajiv Agarwal, Menlo Park, CA (US); Hawk Yin Pang, San Jose, CA (US); Michael Edward Smith Luna, San Jose, CA (US)

(21) Appl. No.: 13/957,383

(22) Filed: Aug. 1, 2013

Related U.S. Application Data
(63) Continuation-in-part of application No. 13/952,552, filed on Jul. 26, 2013.

(51) Int. Cl. H04W 4/00

(52) U.S. Cl. CPC H04W 4/008
USPC 455/41.1; 455/41.2

(57) ABSTRACT

Embodiments relate generally to electrical and electronic hardware, computer software, wired and wireless network communications, electronic media presentation of audio and video, and wearable/mobile computing devices configured to facilitate communication among electronic devices, including mobile phones and media devices that present audio and/or video content. More specifically, disclosed are systems, components and methods to autonomously discover and/control operation of devices, such as media devices, by modulating and demodulating packet characteristics to establish an overlay communication channel. In various embodiments, a method includes receiving at least one RF channel including an overlay communication channel over which packets convey message data modulated with characteristics of the packets. The method includes selecting the RF channel and demodulating a subset of the packet characteristic values to form extracted symbols. At least one method can select a device that autonomously discovers another device using modulated packet characteristics.

### CROSS-REFERENCE TO RELATED APPLICATIONS

This application is a continuation-in-part of U.S. Nonprovisional patent application Ser. No. 13/952,552, filed Jul. 26, 2013, and entitled “Modulation of Packet Characteristics to Establish an Overlay Communication Channel,” which is herein incorporated by reference in its entirety and for all purposes.

### FIELD

Embodiments relate generally to electrical and electronic hardware, computer software, wired and wireless network communications, electronic media presentation of audio and video, and wearable/mobile computing devices configured to facilitate communication among electronic devices, including mobile phones and media devices that present audio and/or video content. More specifically, disclosed are systems, components and methods to autonomously discover and/control operation of devices, such as media devices, by modulating and demodulating packet characteristics to establish an overlay communication channel.

### BACKGROUND

Collaboration among conventional electronics devices has increased with incremental improvements in computational resources and mobile communication abilities. However, modern security requirements for encrypted data and present network communication specifications, among other things, generally impede the user's ability to configure various electronic devices to collaborate with each other. Examples of traditional electronic devices for which collaboration is desired includes mobile telephones, mobile computing devices (including wearable computing devices), and media devices, such as speakers, televisions, tablets, and any other audiovisual equipment.

Typically, a user is required to configure communication accessibility of a new electronic device so that it communicates with other electronic devices, such as a user's mobile phone or network element, such as a wireless router or access point. For example, consider that a user receives an electronic device as a gift and knows little of the manufacturer and the configurability of the device. Should the user desire that the new device interact with other electronic devices, the user normally provides authorization by, for example, entering a login and password to an access point. Once configured, the user's devices might access each other through the access point. Furthermore, consider that a friend of the user visits and/or comes into close proximity to the new device and wishes a personal device to communicate with the new device. In this case, the friend likely does not know the authorization information for the access point, and thus will not be able to have its personal device collaborate with the new device. Such impediments in conventional device collaboration tend to diminish users' experiences in consuming audio and video content, as well as sharing information generally.

While functional, traditional devices and solutions to device collaboration are not well-suited for providing autonomous connectivity among one or more electronic devices. For example, consider situations whether in the business environment or at home in which a number of users seek to access a common computing resource through their multiple devices, such as a media presentation device. Not only do conventional techniques of establishing connectivity impede collaborative efforts among people (e.g., requiring manual intervention and effort, such as multiple authorizations before multiple devices access each other), traditional techniques of controlling a shared computer resource (e.g., media devices, such as speakers, video displays, and the like) are not well-suited to arbitrate control of a shared computing resource by multiple devices. Also, collaborative efforts typically can be hindered when there are numerous devices communicating via multiple wireless channels via an network access point.

Thus, what is needed is a solution for facilitating device collaboration without the limitations of conventional techniques.

### BRIEF DESCRIPTION OF THE DRAWINGS

Various embodiments or examples (“examples”) of the invention are disclosed in the following detailed description and the accompanying drawings:

FIG. 1A illustrates examples of direct and indirect overlay communication channels among a number of devices, according to some embodiments;

FIG. 1B illustrates an example of autonomous device discovery, according to some embodiments;

FIGS. 2A and 2B depict mobile computing devices implementing an autonomous device discovery application, according to some embodiments;

FIG. 3 illustrates an example of a packet characteristic modulator, according to some embodiments;

FIG. 4 illustrates an example of a packet transformer, according to some embodiments;

FIG. 5 is a diagram depicting a device selector, according to some embodiments;

FIG. 6 illustrates an example of the operation of an identifier matcher, according to some embodiments;

FIG. 7 illustrates an example of deriving message data from packets received from an overlay communication channel, according to some embodiments;

FIGS. 8A and 8B illustrate examples of perfecting message data received over an overlay communications channel, according to some examples;

FIGS. 9A and 9B illustrate examples of modulating and demodulating multiple packet characteristics of packets and associated data, according to some embodiments; and

FIG. 10 illustrates an exemplary computing platform disposed in a media device, mobile device, or any computing device, according to various embodiments.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

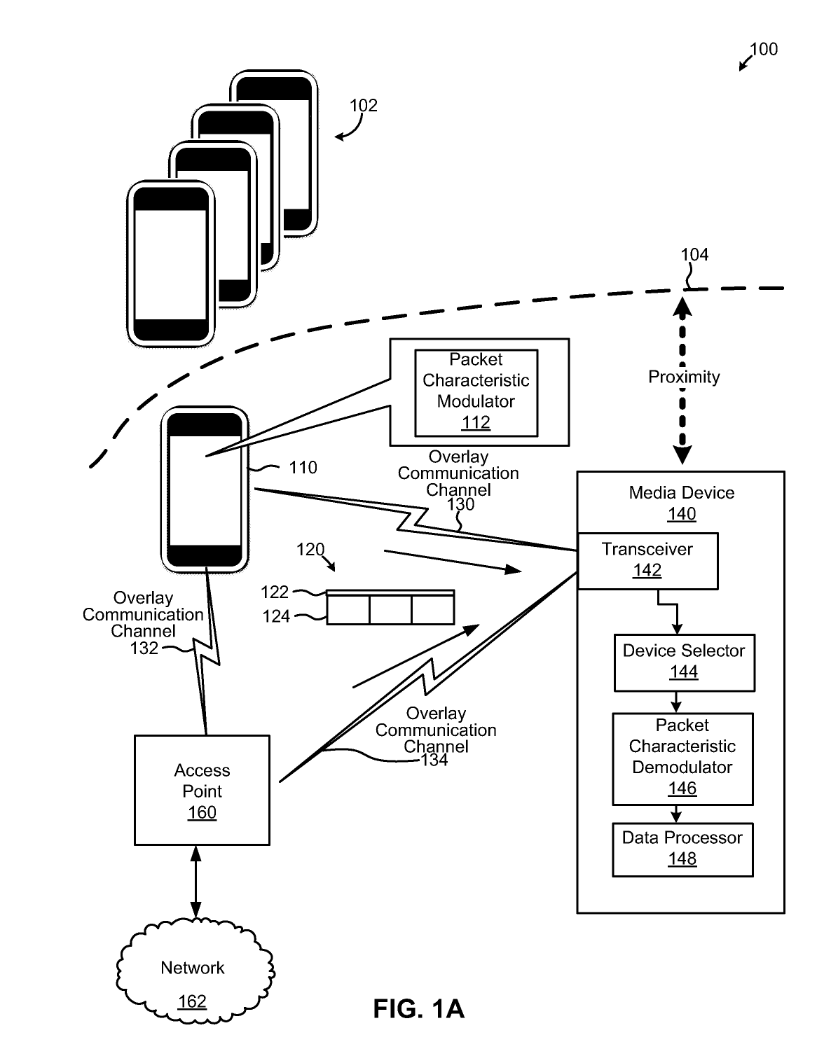

FIG. 1A illustrates examples of direct and indirect overlay communication channels among a number of devices, according to some embodiments. Diagram 100 depicts a number of mobile computing devices 102 and 110 configured to communicate with a shared computing resource, such as media device 140. Mobile computing devices 102 and 110 can be mobile communication and computing devices, such as smart phones, wearable computing devices, and the like. In the example shown, mobile computing devices 102 and 110 are configured to autonomously discover media device 140 via either overlay communication channel 130, which is a direct communication link, or via overlay communication channels 132 and 134, which collectively constitute an indirect communication link. To facilitate formation of the various overlay communication channels 130, 132, and 134, mobile computing devices 102 and 110 each can include a packet characteristic modulator 112 and media device 140 can include a packet characteristic demodulator 146. Further, diagram 100 also depicts an access point 160 (representative of any other networking element) and a network 162. Media device 140 is shown to include a transceiver 142 for transmitting and/or receiving network communications, including, but not limited to, radio frequency (“RF”) signals, and a device selector 144 configured to select at least one device (e.g., from mobile computing devices 102 and 110) for controlling at least one operation of media device 140. Media device 140 also is shown to include packet characteristic demodulator 146 and a data processor 148.

In at least some embodiments, mobile computing devices 102 and 110 include computational resources including processors, logic, and/or execute instructions to control operation of media device 140, which, in turn, is configured to determine a source of data, such as a source of media data, upon which to operate. Mobile computing devices 102 and 110 are sources of control data with which media device 140 consumes to determine, for example, the sources of data that media device 140 is to access. Mobile computing device 110 can be a source of media data (e.g., a user's stored audio or video content), or a source of media data can be accessed via access point 160 and network 162. Examples of sources of media data accessible via access point 160 and network 162 include music streaming services, media providers (e.g., cable video, satellite video, websites, etc.), teleconference providers/devices, etc.). In some instances, any of mobile computing devices 102 and 110 can “hand-off control” of media presentation (e.g., presentation of audio and/or video) to media device 140, which, in turn, can return control back to the mobile computing device that originally passed off control.

In some embodiments, the overlay communication channels enable mobile computing devices 102 and 110 to discover autonomously media device 140, and in response to being discovered, media device 140 can provide connectivity to the mobile computing devices. Although media device can offer or provide connectivity (simultaneously or nearly simultaneously), media device 140 can operate to restrict or otherwise select which of mobile computing devices 102 and 110 can assert control over media device 140, according to some embodiments. Device selector 144 can operate to at least prioritize access of each of the mobile computing devices 102 and 110, whereby higher-prioritized devices are permitted control over media device 140. In at least one non-limiting example, one of mobile computing devices 102 and 110 is permitted to control the media device 144 during specific periods of time. According to some embodiments, device selector 144 can be configured to select one of mobile computing devices 102 and 110 based on one or more criteria. In some examples, device selector 144 selects a mobile computing device, such as mobile computing device 110, that is “in proximity” to media device 140. In the example shown, a boundary 104 depicts a line of demarcation of “proximity.” Boundary 104 is shown to lie at a distance from media device 140, whereby the distance can be any distance. In at least some embodiments, the term proximity can describe a negligible distance, such as in situations where a mobile computing device 110 is placed very close to, or on top of, media device 140. For example, media device 140 can detect that one of its surfaces is near, or in contact with, a surface of mobile computing device 110. Device selector 144 then can selectively grant control to mobile computing device 110. Should one of mobile computing device 102 move in proximity closer to media device than mobile computing device 110, then device selector 144 can prioritize the one mobile computing device 102 higher, thereby handing control to that device. Device 110 then would lose ability to control media device 140, at least in some examples. While device selector 144 can use proximity or distance to select a controlling device, other techniques are possible. For example, unique identifiers associated with each of the mobile computing devices can be transmitted via the overlay communication channels to media device 140. Media device 140 can use the unique identifiers to uniquely identify the origin of received packets for purposes of determining which device ought to have control over media device 140.

To facilitate autonomous discovery of media device 140 by any of mobile computing devices 102 and 110, each of the computing devices can include packet characteristic modulator 112 to form one or more overlay communication channels with media device 140. As media device 140 includes a packet characteristic demodulator 146, media device 140 therefore can receive packet data over the overlay communication channels. In some embodiments, packet characteristic modulator 112 is configured to modulate at least one packet characteristic of packets transmitted via the overlay communication channels. The packets include encoded symbols based on message data 102. For example, packet characteristic modulator 112 can modulate a packet characteristic as a function of a value associated with a symbol from message data to be conveyed or transmitted autonomously. Examples of symbols include characters, text, letters, numbers, control characters, ASCII characters, and the like. Therefore, packet characteristic modulator 112 can modulate a characteristic of a packet 124 to include a modified packet characteristic. In the example shown, the modified packet characteristic is overlaid upon, embedded in, or otherwise associated with protocol packet 124, whereby a transformed packet 120 includes protocol packet 124 and its modified packet characteristic 122. In some examples, overlay communication channel 130 is composed of a number of modified packet characteristics 122 overlaid upon a stream of protocol packets 124. According to some embodiments, packet characteristic modulator 112 can be configured to modulate multiple packet characteristics to compress symbol data into fewer packets than otherwise might be the case. For example, packet characteristic modulator 112 can be configured to modulate three different packet characteristics. Consequently, packet characteristic modulator 112 can operate to compress the encoding of three symbols into fewer packets (e.g., into one or two packets).

By contrast, packet characteristic demodulator 146 of media device 140 is configured to detect (e.g., “sniff”) transformed packets 120 and to extract such packets from a stream of packets on one or more channels that includes other packets. Packet characteristic demodulator 146 is configured to obtain or acquire packet characteristic values, each of which corresponds to a symbol. Also, packet characteristic demodulator 146 is configured to identify a characteristic of transformed packet 120, and demodulate the characteristic to extract a symbol therefrom. Further, packet characteristic demodulator 146 is configured to assemble the demodulated packets to form message data. According to some embodiments, packet characteristic demodulator 146 can be configured to demodulate multiple packet characteristics to decompress encoded symbol data to provide more symbols from fewer packets than otherwise might be the case. For example, packet characteristic demodulator 146 can be configured to demodulate three different packet characteristics. Consequently, packet characteristic demodulator 146 can operate to decompress the encoding of one packet to yield three symbols. In some examples, packet characteristic demodulator 146 can be configured to certify that data received over the overlay communication channel is valid and/or correct, and can perform certain operations to correct missing or erroneous encoded symbol data.

As used herein, the term “overlay communication channel” can refer to, at least in some embodiments, a parasitic data communications channel overlaid upon (e.g., piggybacked upon), embedded in, or otherwise associated with a communication channel typically composed of a stream of networking protocol packets configured to travel between two or more network connections. The networking protocol packets can be specified by various known protocols and protocol stacks. In some examples, packet characteristic modulator 112 can establish or otherwise implement protocol packet 124 to specifically convey modified packet characteristic data 122. In other examples, packet characters modulator 112 can implement modified packet characteristic data 122 in connection with protocol packets 124 that are intended for another use. To illustrate, consider that mobile computing device 110 is generating protocol packets 124 destined for a computing device that is not shown over a communication channel. Thus, payload data of protocol packets 124 can be encrypted and can have a specific use other than communicating data from mobile computing device 110 to media device 140. Modified packet characteristic data 122 can therefore parasitically communicate to media device 140 based on protocol packets 124 bound for other devices. Thus, media device 140 can receive these packets, and packet characteristic demodulator 146 can extract symbols from modified packet characteristic data 122, regardless of the payload of protocol packet 124. Examples of communication links that provide for direct communication, such as an association with overlay communication channels 130, include Bluetooth®, Wi-Fi Direct™, NFC, and other like specifications.

In view of the foregoing, the functions and/or structures of either packet characteristic modulator 112 or packet characteristic demodulator 146, or both, can provide for the formation of overlay communication channel 130, which, in turn, can facilitate electronic device collaboration. Electronic device collaboration includes, but is not limited to, autonomous discovery of an electronic device, such as the autonomous discovery of media device 140. In some embodiments, overlay communication channels 130, 132, and 134 can be unidirectional communication links from mobile computing device 110 to media device 140, whereby the unidirectional communication link can be formed independent of authorization data that establishes a session or any other type of electronic communicative interaction between mobile computing device 110 and media device 140. Further, packet characteristic modulator 112 and packet characteristic demodulator 146 can be configured to modulate and to demodulate, respectively, accessible packet characteristics. An accessible packet characteristic is publicly accessible and non-encrypted (i.e., may not subject to encryption)—regardless of whether the payload or the packet is encrypted in accordance with protocol specifications, such as set forth in protocol stacks. Thus, packet characteristic modulator 112 and packet characteristic demodulator 146 can establish a communication link to discover suitable electronic devices, such as media device 140, with which to collaborate. Such discovery can occur with negligible to no delays imposed by authentication processes and/or encrypted packet data. Moreover, packet characteristic modulator 112 and packet characteristic demodulator 146 can modulate and demodulate, respectively, packet characteristics in a compressive and decompressive manner. Specifically, packet characteristic modulator 112 can compress encoded symbol data into fewer packets than otherwise might be the case. As such, compression of modified packet characteristics can facilitate the use of fewer packets and autonomous device discovery, which, in turn, can provide faster data communications over the overlay communication channels.

Transceivers, such as transceiver 142, can be implemented as either transmitters or receivers, or both, and can provide communication channels over any network (e.g., any data network), such as IP networks, Bluetooth® networks, cellular networks, etc. Such transceivers can implement or otherwise cooperate with the use of protocol stacks, which include protocol specifications from low-level OSI layers (e.g., physical layer) up through high-level OSI layers (e.g., application layer). A protocol specification (or equivalents) can provide for definitions of one or more packet characteristics that can be modulated and demodulated, according to various examples described herein. Communication protocol requirements of the protocol stacks can implement a variety of protocols, such as Internet Protocols (e.g., TCP/IP protocol stacks) including Internet Control Message Protocol (“ICMP”) and the like, Ping protocols (e.g., “echo reply” ICMP), ARP-related protocols, Bluetooth® protocols and protocol stacks, security protocols (e.g., SSL, HTTPS, etc.), Simple Mail Transfer Protocol (“SMTP”), and the like.

Data processor 148 is configured to interpret and/or execute commands, if any, that are transmitted via the overlay communication channels. For example, data processor 148 can determine whether a command specifies media device 140 is to perform a media related operation, like playing audio, from a specific source of media data. Thus, data processor 148 can operate to identify a source of media based on message data received over the overlay communication channels, and form a network connection with an entity, such as a music streaming service and/or server. Thereafter, data processor 148 can facilitate receiving streaming media for consumption by media device 140.

According to at least some examples, packet characteristic modulator 112 and/or packet characteristic demodulator 146 can facilitate the use of modulating and demodulating, respectively, packet characteristics of ping protocol packets 124 to form the overlay communication channels. In one example, packet characteristic modulator 112 and packet characteristic demodulator 146 can be configured to modulate and demodulate, respectively, packet characteristics by modifying packet lengths of the packets. Any type or number of packet characteristics may be modulated or demodulated, according to various embodiments to encode and decode one or more symbols in one or more packets. For example, packet characteristic modulator 112 and packet characteristic demodulator 146 can be configured to modulate and demodulate packets in a compressive manner and a decompressive manner, respectively.

In some examples, access point 160 can provide Wi-Fi and Ethernet access to a variety of networks. As an example, access point 160 can generate numerous Wi-Fi channels, such as 11 channels of RF signals at 2.4 GHz, and 26 channels of RF signals on 5 GHz. However, overlay communication channels can be implemented with a variety of communication protocol requirements, such as those found in protocol stacks, and is not limited Wi-Fi. For example, overlay communication channels can be implemented using Bluetooth protocol stacks, TCP/IP, and other protocols.

Examples of packet characteristic modulator 112 or packet characteristic demodulator 146 are described in U.S. Nonprovisional patent application Ser. No. 13/xxx,xxx, filed MM DD, YYYY with Attorney Docket No. ALI-284, and entitled “Modulation of Packet Characteristics to Establish an Overlay Communication Channel,” which is herein incorporated by reference in its entirety and for all purposes.

An example of media device 140, as well as examples of its components or elements, are disclosed in U.S. patent application Ser. No. 13/831,422, entitled “Proximity-Based Control of Media Devices,” filed on Mar. 14, 2013 with Attorney Docket No. ALI-229, which is incorporated herein by reference. In various examples, media device 140 is not limited to presenting audio, but rather can present both visual information, including video (e.g., using a pico-projector digital video projector or the like) or other forms of imagery along with (e.g., synchronized with) audio. At least some components of media device 140 can be implemented similarly as Jambox® products produced by AliphCom, Inc., of California.

FIG. 1B illustrates an example of autonomous device discovery, according to some embodiments. Diagram 180 depicts mobile computing device 110 configured to communicate message data to media device 140 via either overlay communication channel 130 or a combination of overlay communication channels 132 and 134. By modulating and demodulating accessible packet characteristics, at least in some embodiments, mobile computing device 110 can autonomously discover media device 140 at a point in time at which mobile computing device 110 and media device 140 do not include data about the other (i.e., mobile computing device 110 and media device 140 are not connected to each other up until the point in time at which autonomous discovery is initiated). Therefore, media device 140 can receive or otherwise “learn” or become “aware” about mobile computing device 110 and its data (i.e., personal data). Examples of such learned data include, but are not limited to, a playlist, audio files, login identifiers, passwords, and the like. Thus, media device 140 can obtain this data autonomously without requiring mobile computing device 110 or its user to upload (e.g., manually upload) or otherwise pass along such data.

To illustrate, consider that a user of mobile computing device 110 recently purchases media device 140. Prior to powering up media device 140, mobile computing device 110 includes login and password data for the access point as well as a remote music streaming service. Upon powering up media device 140 for the first time in proximity to mobile computing device 110, mobile computing device 110 can perform autonomous device discovery to discover media device 140, and then transmit login and password data (e.g., for both the access point and a remote music streaming service) to media device 140. As another illustration, consider that a user of mobile computing device 110 visits a business associate who recently purchased media device 140 to present audio and/or video. The user of mobile computing device 110 does not know login IDs or passwords for the business associate's electronic devices, including media device 140, access point 160, network elements, such as routers, or other networked devices. Consider, however, that media device 140 has been in use with access point 160, and, thus, is already logged into access point 160. The visiting user can autonomously discover media device 140 directly via overlay communication channel 130 to thereby establish a communication link. With a communications link established between mobile computing device 110 and media device 140, URL login and password data from mobile communications device 110 can be transmitted to media device 140 via overlay communication channel 130 or any other communications link.

In the example shown in FIG. 1B, an access point 160 is interposed between network 162 and both mobile computing device 110 and media device 140. Mobile computing device 110 generates message data that specifies an operation (e.g., audio/video playback, or initiating a teleconference) and the source of media (e.g., a website of a music streaming service). Mobile computing device 110 thus can transmit message data in transformed packets 120 as modified packet characteristics 122, which can represent one or more modified packet characteristic. For example, the message data can include access point (“AP”) login data 184, access point (“AP”) password data 186, URL login data 192, and URL password data 194. Playlist data also can be included. Media device 140 and/or data processor 148 can receive this information, and in response, perform an audio presentation operation. For example, data processor 148 can establish a network connection via path 182 using access point login data 184 and access point password data 186 to cause media device 140 to log into access point 160. The data processor 148 can then establish a communication link between access point 160 and network 162 by using URL login data 192 and URL password data 194 to gain access to a remote music streaming service to receive streaming music data 190b bound for media device 140. Alternatively, path 182 can extend from access point 160 to mobile computing device 110 from which media data 190a can be transmitted to media device 140 to perform a media-related operation.

Accordingly, mobile computing device 110 can autonomously hand-off control of, for example, the streaming of music from the Internet to media device 140 by passing along message data that facilitates music streaming (e.g., login information, passwords, and playlists for third party music-serving entities). Furthermore, the overlay communication channels can be parasitic in nature, and, thus, can be transmitted in association with packets bound for other devices, thereby forgoing a requirement to generate packets, at least in some cases, that are specifically designed to transport modified packet characteristic data 122. In some cases, this may reduce computational resource requirements and data packet traffic over a local network.

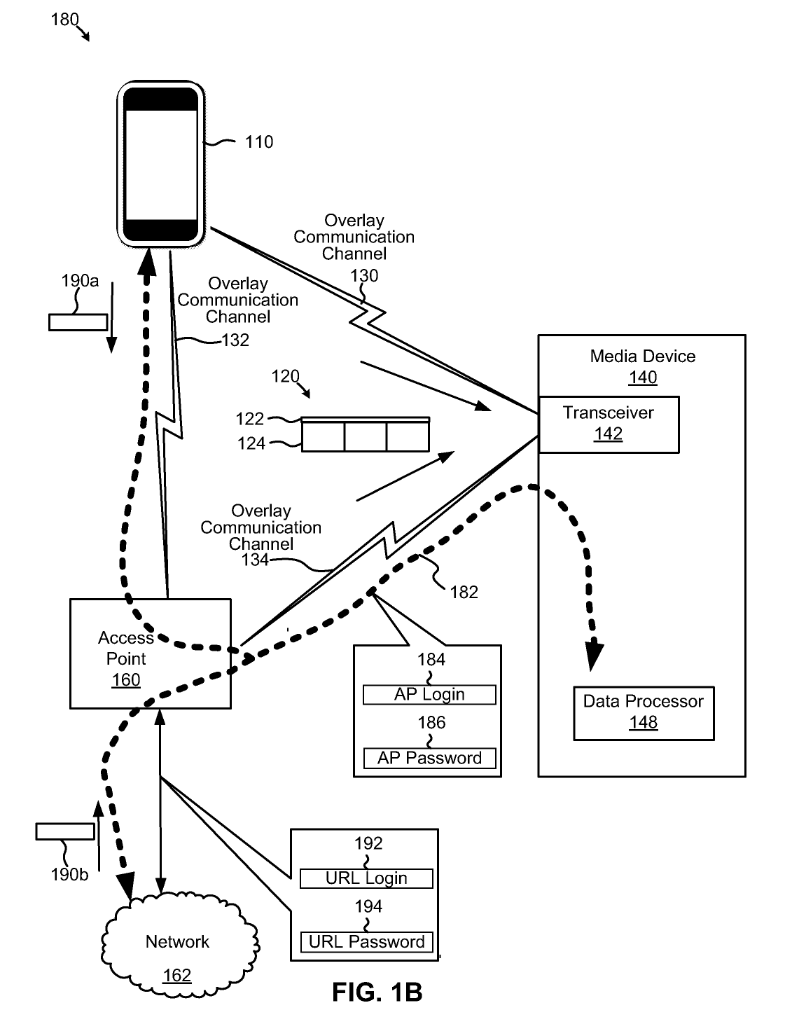

FIGS. 2A and 2B depict mobile computing devices implementing an autonomous device discovery application, according to some embodiments. Diagram 200 of FIG. 2A depicts a mobile computing device 210 having a user interface 211, a processor 220, and a memory 230. As shown, memory 230 includes executable instructions constituting an autonomous device discovery application 232.

For example, autonomous device discovery application 232 can include instructions that cause, for example, processor 220 to receive signals from user interface 211, among other sources of signals. Autonomous device discovery application 232 may generate an icon (“AD”) 212 on user interface 211 to initiate autonomous device discovery. When a user selects icon (“AD”) 212, a signal can be received by autonomous device discovery application 232, which, in turn, can cause transmission of transformed packets (including message data) via a radio transmitter to form an overlay communication channel. The message data can specify a network address (e.g., a URL, IP address, a Bluetooth MAC ID, etc.) as a source of data. Autonomous device discovery application 232 may also cause acquisition of a subset of packet characteristic values based on modulation of packet characteristics and symbols of the message data, whereby a plurality of packet characteristics of a packet can be modulated to form a transformed packet. The characteristics of packets can be specified as a function of a packet protocol, such as a ping protocol (or ICMP). Also, autonomous device discovery application 232 can also cause transmission of transformed packets via an overlay communication channel.

In various embodiments, autonomous device discovery application 232 can provide for compression during modulation of packet characteristics. Further, autonomous device discovery application 232 can implement multiple network protocols for purposes of establishing a variety of overlay communication channels based on different protocols. For example, autonomous device discovery application 232 may generate a Bluetooth-based overlay communication channel using modulated Bluetooth packet characteristics, and a Wi-Fi-based overlay communications signals using modulated SMTP or ping protocol packet characteristics. In some cases, a packet characteristic modulator is formed in processor 220, in other logic (not shown), or in a portion of autonomous device discovery application 232.

FIG. 2B is a diagram 250 that depicts a mobile computing device including memory 270, which, in turn, includes autonomous device discovery application 272 and autonomous connection data 274. In the example shown, a user can enter relevant login and password data into fields 252. In some cases, autonomous device discovery application 272 can be configured to access URL password and login data from a user's browser in the mobile computing device, as well as access point login and password data from networking information saved in memory 270. Autonomous connection data 274 can include data, such as AP and URL password and login data.

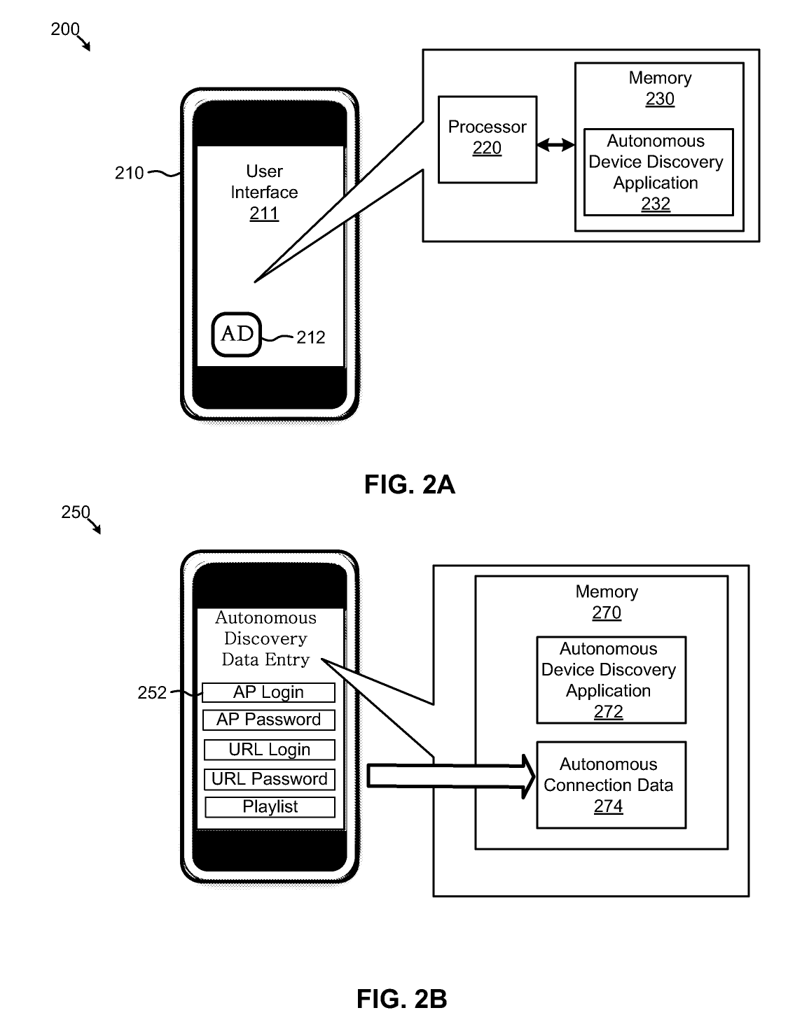

FIG. 3 illustrates an example of a packet characteristic modulator, according to some embodiments. Diagram 300 depicts an example of a packet characteristic modulator 320 that includes a packet transformer 324, a repository 326, which can include symbol transform data 327, an overlay communication channel manager 328, and a packet constructor 330. In some embodiments, repository 326 can include transformed symbol data representing values of modified packet characteristics of a predetermined message. Packet characteristic modulator 320 is configured to receive symbols, and is further configured to modulate packet characteristics to encode the symbols into packets depicted in packet streams 352, 354, and 356. In some embodiments, packet characteristic modulator 320 is configured to receive an instruction to transmit transformed packets including message data composed of symbols over an overlay communication channel. The instruction can be transmitted as a signal, which can originate from a user interface 211 of FIG. 2A (e.g., responsive to an input from a user to establish the overlay communication channel to discover unknown compatible devices). Alternatively, processor 220 of FIG. 2A can be configured to generate an instruction signal to perform autonomous device discovery responsive to, for example, the expiration of a periodic or aperiodic timer (e.g., packet characteristic modulator 320 can, from time-to-time, automatically search for collaborative devices). In some cases, processor 220 of FIG. 2A can be configured to generate an instruction signal responsive to detection of the presence of radio frequency signals from devices that may be able to demodulate packets of packet streams 352, 354 and 356. In some examples, the instruction signals can include data representing a password and an operation to initiate presentation of audio and/or video at the receiving device.

In the example shown, message data can include symbols that constitute one or more of a URL login 302a, a URL password 302b, a playlist 304 (e.g., data representing a list of audio tracks, sounds, or songs), an access point (“AP”) login 306a, an access point (“AP”) password 306b, and/or any other data 308. Packet transformer 324 can be configured to perform, or control, transformation of protocol packets and the modification of their characteristics so that the packets include data representing encoded symbols. Packet transformer 324 can acquire packet characteristic values used to encode symbols of the message data from, for example, repository 326, whereby each packet characteristic value corresponds to a unique symbol. In some embodiments, specific symbols are predetermined prior to the construction of transformed packets for transmission as packet streams 352, 354, and 356. In this case, predetermined transformed symbol data (not shown) can be acquired by packet transformer 324 to modify packet characteristics. The transformed symbol data can include a data arrangement of packet characteristic values ordered similar to the order of the symbols, but can be generally predetermined such that packet transformer 324 need not modify the characteristics of packets in real-time. Packet characteristic values, and the order thereof, thus are predetermined (i.e., packet characteristic values need not be calculated on-the-fly). In alternate embodiments, symbols are not predetermined and, for example, can be supplied by a user via a user interface (e.g., on-the-fly). For example, a user can enter symbols in “real-time” into fields 252 of FIG. 2B, which are operated upon by packet characteristic modulator 320 of FIG. 3. In this case, packet transformer 324 can be configured to identify a symbol and perform a look-up (or some other transformation operation) in connection with symbol transform data 327. Also, a corresponding packet characteristic value can be received from symbol transform data 327. In some embodiments, the packet characteristic value from symbol transform data 327 represents a modulated symbol modulated with a packet characteristic.

Packet transformer 324 is shown to include a packet characteristic data compressor 325 that is configured to adjust values of multiple packet characteristics as a function of packet characteristic values retrieved from repository 326. The values can be adjusted during packet construction performed by packet constructor 330, which can be coupled to a protocol stack 340 and to an overlay communications manager 328. Protocol stack 340, for example, can be configured to provide network protocol specifications or definitions to packet constructor 330 for constructing transformed packets in accordance with operation of a packet protocol (e.g., a ping protocol).

Accordingly, packet characteristic data compressor 325 can be configured to modulate (or control modulation of) multiple characteristic of packets. Such packets can be specified by a network protocol of protocol stack 340 as a function of the packet characteristic values. Packet characteristic data compressor 325 can modulate multiple packet characteristics to compress symbol data into fewer packets than otherwise might be the case. In a specific example, packet characteristic modulator 320 can be configured to modulate three different packet characteristics. Consequently, packet characteristic modulator 320 can operate to compress the encoding of three symbols into fewer packets (e.g., one or two packets).

Responsive to packet characteristic values provided by packet characteristic adjuster to 325, packet constructor 330 forms transformed packets of packet streams 352, 354, and 356. A transformed packet can be a protocol packet, such as a ping packet, configured to include one or more modified packet characteristics that encode one or more symbols into, or in relation to, a corresponding packet. In some examples, overlay communications manager 328 is optional. Overlay communications manager 328, at least in some embodiments, can manage the transmission of transformed packets via the overlay communication channel to maintain an order set forth by the symbols. In some embodiments, overlay communications manager 328 is configured to implement, insert, or otherwise provide transformed packets into one of packet streams 352, 354, and 356. According to one embodiment, overlay communications manager 328 includes a unique identifier (“ID”) manager 329 that is configured to cause a unique identifier to be modulated into one or more packets. An example of a packet encoded with a unique identifier (“UID”) is depicted as packet 357. In at least one instance, unique identifier (“ID”) manager 329 can be configured to determine symbols constituting an identifier associated with a mobile device, to identify packet characteristic values for the symbols, and to modulate at least one packet characteristic of the packet to include the UID. In at least some embodiments, the unique identifier can identify either a user or a mobile computing device uniquely. A non-limiting example of a unique identifier is a MAC address of a mobile computing device. The inserted packets may include modified packet characteristics that specify one or more of a command (e.g., a command identifier indicating subsequent transformed packets include a command), application data (e.g., an application identifier indicating subsequent transformed packets include application data), and overlay checksum specifying a checksum of multiple values of modified packet characteristic (to confirm accurate data transmission), and/or the like. This information may be used to facilitate demodulation at a recipient device.

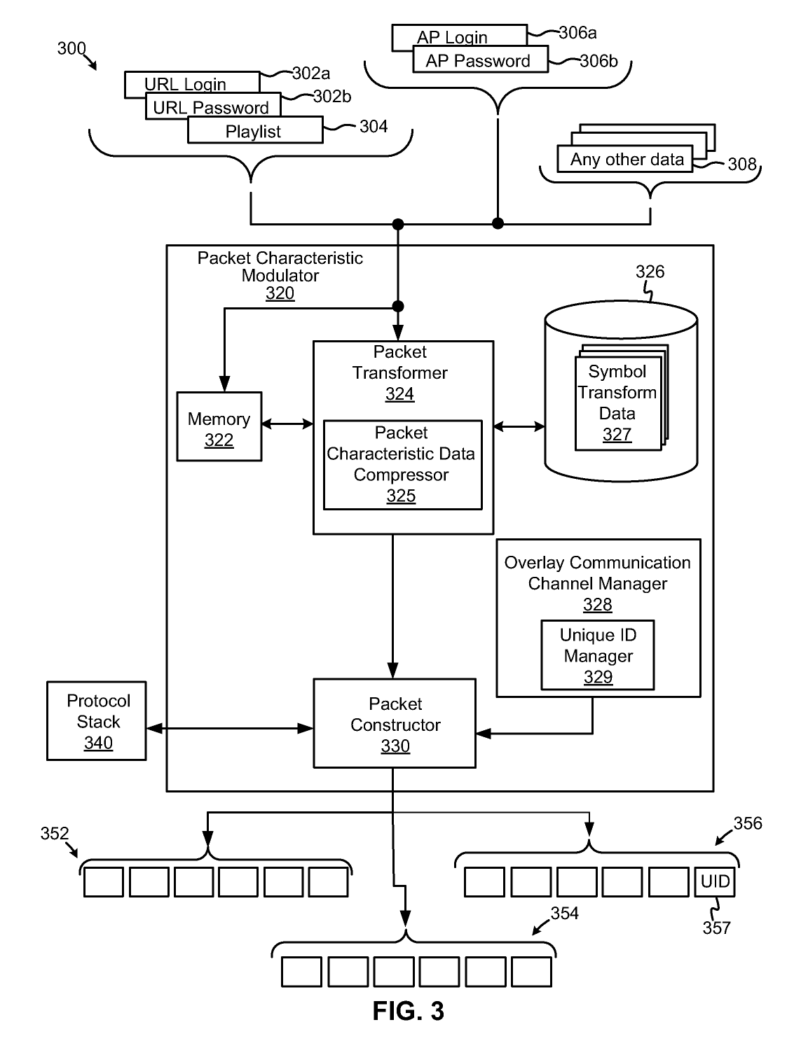

FIG. 4 illustrates an example of a packet transformer, according to some embodiments. Diagram 400 depicts an example of a packet transformer 410 that includes a packet characteristic data compressor 420 that is implemented as multiple packet characteristic adjusters. In the example shown, packet characteristic data compressor 420 includes packet characteristic adjuster (“1”) 421, packet characteristic adjuster (“2”) 422, packet characteristic adjuster (“3”) 423, and packet characteristic adjuster (“n”) 424. Diagram 440 also includes a packet constructor 440 and a repository 430 including symbol transform data 432 and compression control data 434. Packet transformer 410 also is shown to include a symbol selector 412.

Packet characteristic transformer 410 is configured to receive symbols 402, and is further configured to modulate packet characteristics to encode symbols 402 with packets, such as packet 450. Diagram 400 also depicts a repository 430 including symbol transform data 432, which can include data representing associations between specific symbols and corresponding packet characteristic values. As multiple packet characteristics can be modulated, different symbols can be associated with different packet characteristics (and thus have different packet characteristic values). Symbol transform data 432 can be similar to equivalently-named elements of FIG. 3.

To illustrate operation of packet transformer 410, consider that a symbol selector 412 determines a quantity of symbols that can be modulated in association with a packet. Depending on the sizes of the data representations for the modulated packet characteristic values, symbol selector 412 can determine that, for example, 2 to 4 symbols may be encoded into one packet 450. Compression control data 434 of repository 430 can include data that is used by symbol selector 412 to determine how to optimally modulate packet characteristics to enhance data compression. For example, as shown in diagram 460, symbol selector 412 determines first that symbols “C” and “4” can be modulated into packet 450. Further to diagram 460, symbol “2” can also be included. Therefore, symbols “C,” “4,” and “2” can be modulated with packet characteristics to yield modified packet characteristic data 452 of packet 450.

In this example, packet characteristic adjuster (“1”) 421 is configured to adjust a first packet characteristic, such as the packet length (“PL”) 462 of packet 461a. The payload (“P”) size can be adjusted, for example, to adjust the value of the packet length. The adjusted or modified value then represents a modified packet characteristic for packet 461a. Packet characteristic adjuster (“2”) 422 is configured to adjust a second packet characteristic, such as a header type (“H”) of packet 461b. As shown, the header type can be modified to “Type Y” to encode a corresponding symbol. Further, packet characteristic adjuster (“3”) 423 is configured to adjust a third packet characteristic, such as a checksum length (“CL”) of packet 461c. As shown, the checksum length can be modified to “CL Y” to encode a corresponding symbol. Packet constructor 440 is configured to modify the above-described three packet characteristics to modulate symbols “C, 4, 2” to form modified packet characteristics data 452 in association with a protocol packet 454 (e.g., a single packet). Note that in some embodiments, the packet length, header type, and checksum length are publicly-accessible characteristics. Thus, symbols “C, 4, 2” can be modulated on top of packet 454 regardless of whether an encrypted payload is present.

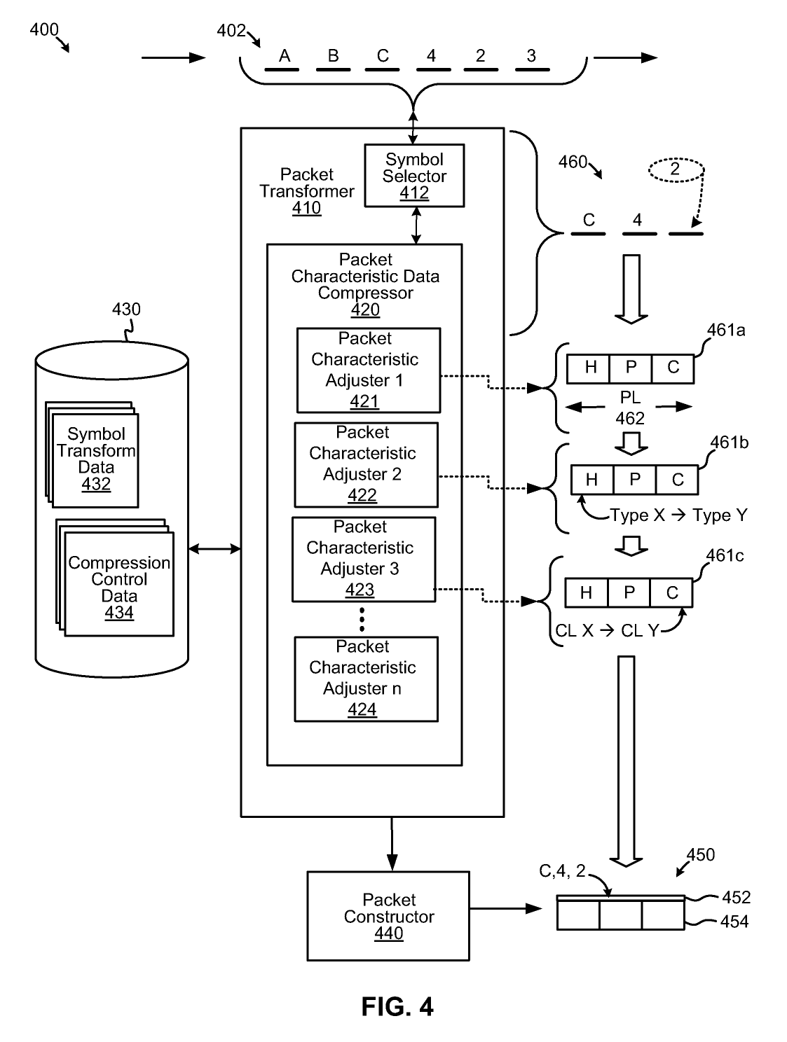

FIG. 5 is a diagram depicting a device selector, according to some embodiments. Diagram 500 depicts a device selector 544 including a signal strength determinator 510, a candidate packet extractor 512, and a candidate packet stream selector 520. Also shown in diagram 500, is a transceiver 504 configured to receive any number of radio frequency signals or RF channels 502. Channels 502 can originate, or be formed by, an access point capable of transmitting over 30 or more RF channels. One or more RF channels may include one or more overlay communication channels over which packets can convey message data modulated with characteristics of packets. Device selector 544 is configured to determine which of a number of transmitting computing devices in communication with, for example, a shared computing resource can assert control over a receiving device (e.g., media device, etc.). In some embodiments, device selector 544 can be configured to determine proximities of one or more devices (e.g., mobile computing devices) associated with one or more RF channels, and further configured to select at least one RF channel based on a proximity of a device relative to a media device. Proximity can be determined in a variety of ways.

In one embodiment, device selector 544 selectively monitors each of channels 502 to determine whether any RF channel is a candidate source of packets associated with a transmitting device, such as a mobile computing device, that may be in a mode of autonomous device discovery. Signal strength determinator 510 is configured to determine a signal strength for RF signals received into transceiver 504. In some examples, the signal strength can be expressed in, or associated with, a received signal strength indicator (“RSSI”), which is a measurement of a relative power level in a received radio signal. Signal strength determinator 510 operates to monitor the signal strength in each of the channels for specific periods of time to determine whether the power level associated with a monitor channel is above a “candidate threshold value.” The candidate threshold value is “threshold signal strength value” representing a level of power associated with transmission of packets over an RF channel from a transmitting device that may be in autonomous device discovery mode. Signal strength determinator 510 can monitor each of the RF channels in a round-robin fashion or in any other manner.

Packets associated with an RF channel having power levels that surpass or exceed the candidate threshold value can be identified, extracted, stored or otherwise evaluated by candidate packet extractor 512. As such, candidate packet extractor 512 is configured to extract packets and/or streams of packets associated with RF channels that exceed the candidate threshold value to form a pool of candidate packets. Such packets can be referred to as “candidate packets,” according to some examples. Candidate packet extractor 512 can be configured to extract subsets of packets from a number of packet streams. In operation, candidate packet extractor 512 can function to “sniff” packets or otherwise monitor packets received from transceiver 504 (e.g., using Wi-Fi monitor modes, Radio Frequency Monitor mode, etc.) to identify and extract packets of interest. In some cases, certain protocol packets (e.g., ping packets) can be extracted to test whether the packet characteristics provide coherent and valid message data rather than random data (e.g., of an intended ping operation).

Candidate packet stream selector 520 is configured to select or otherwise identify from the candidate pool of packet streams which RF channel and packet stream has, for example, the greatest power level associated therewith. In some embodiments, candidate packet stream selector 520 can include a proximity detector 522 and an identifier matcher 524. A proximity detector 522 is configured to determine whether a mobile computing device is within a proximity in which it has a highest priority, and, therefore, is selected as the device to control the media device. In some examples, proximity detector 522 is configured to use one or more near field communications (“NFC”) signals to determine whether a mobile computing device is in a region adjacent to the media device such that device is to be selected. In some cases, proximity detector 522 is configured to classify a specific mobile computing device as a controlling device if the mobile computing device is at a negligible distance, such as in situations where a mobile computing device is placed very close to, on top of, or in contact with a media device.

Identifier matcher 524 is configured to analyze the unique identifier associated with each stream of packets. The unique identifier can be used to classify a mobile computing device as a controlling device if, for example, the packet stream includes valid data that is expected to be received over an overlay communications channel. In some examples, demodulated packet data 525 can be provided by packet characteristic demodulator 746 to determine whether the demodulated symbols constitute a valid message. If the unique identifier can be associated with a valid data, then the corresponding device can be classified as a controlling device (i.e., the device that controls the media device). But for unique identifiers that are associated with invalid data (e.g., random data in a ping protocol), then the packets associated with those identifiers are not deemed to be controlling devices.

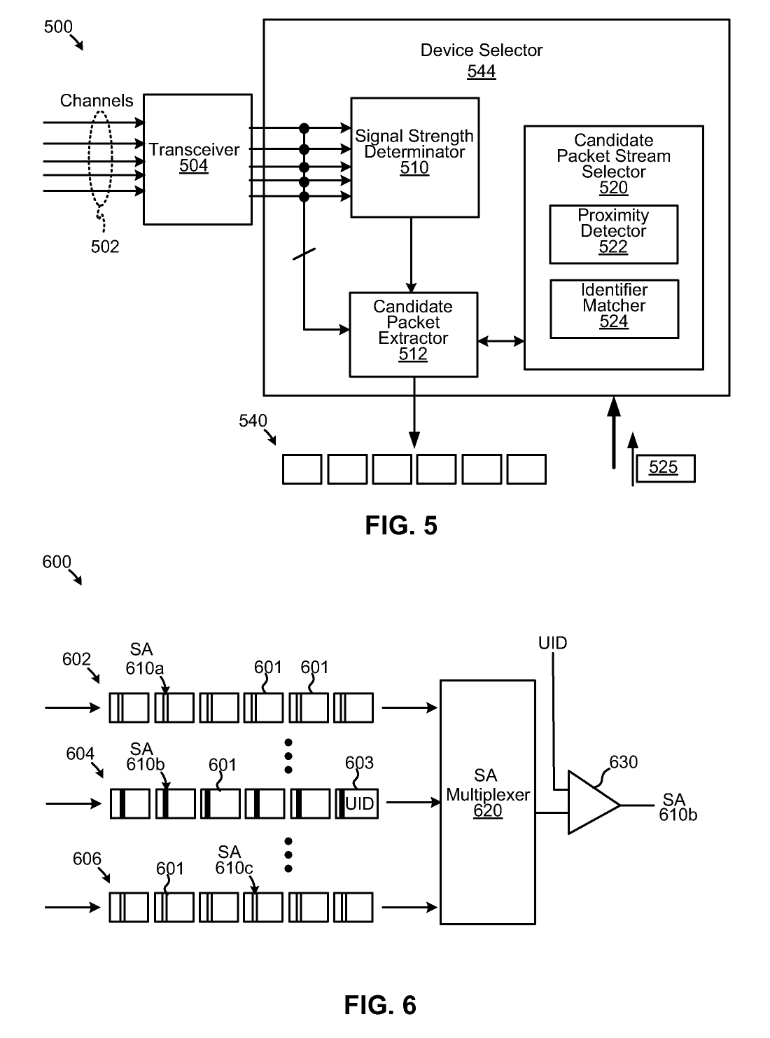

FIG. 6 illustrates an example of the operation of an identifier matcher, according to some embodiments. Diagram 600 depicts streams of packets in which the source addresses (e.g., MAC addresses or the like) are matched against the extracted symbols of a unique identifier (“UID”) to determine whether to classify a device as a controlling device. As shown, packet streams 602, 604, and 606 are fed into a source address (“SA”) multiplexer 620, the output of which is fed into a comparator 630. The other input into comparator 630 is a unique identifier (“UID”), which can be a MAC address (or a variant thereof), that is extracted from a candidate packet stream. Diagram 600 depicts packet stream 602 including packets 601 having source addresses 610a, whereas packet stream 604 includes packets 601 having a source address 610b and packet stream 606 includes source addresses 610c. Note that the unique identifier (“UID”) for one of the inputs of comparator 630 is extracted from and/or demodulated from packet 603 of packet stream 604. Upon a match between a source address 610b and the unique identifier (“UID”) by comparator 630, the positive match yields source address 610b. As such, identifier matcher 524 can be used to identify packet stream 604 as being associated with a controlling device.

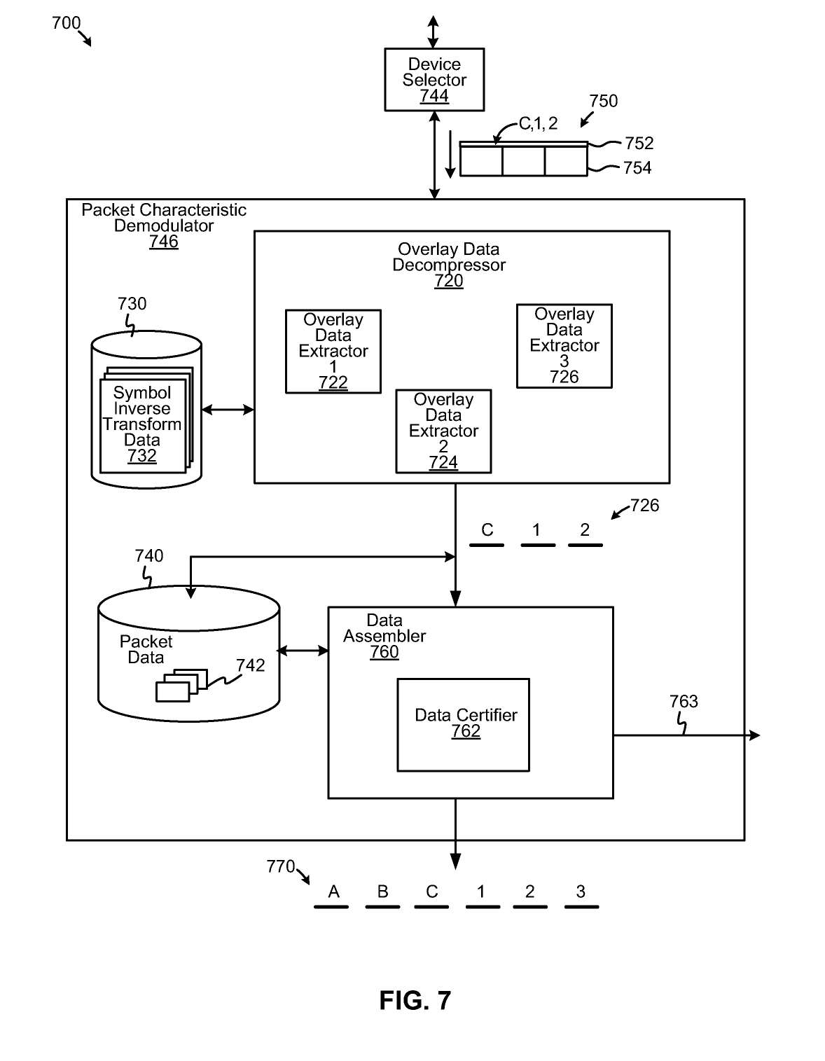

FIG. 7 illustrates an example of deriving message data from packets received from an overlay communication channel, according to some embodiments. Diagram 700 depicts an example of a packet characteristic modulator 746 that includes an overlay data decompressor 720, a repository 730 configured to store data representing symbol inverse transform data 732, an optional repository 740 configured to store packet data 742, and a data assembler 760. A packet 750 (or groups of packets 750) is received from a device selector 744, whereby the packets include modulated packet characteristics that include encoded symbol data. In this example, packet 750 includes compressed data. For example, multiple modified packet characteristics 752 includes encoded symbols “C,” “1,” and “2” with a protocol packet 754.

Overlay data decompressor 720 is configured to decompress and decode the modulated packet characteristics. That is, overlay data decompressor 720 is configured to extract symbols “C,” “1,” and “2” from packet 752 to yield three symbols 726. Overlay data decompressor 720 includes any number of overlay data extractors. In this example, overlay data decompressor 720 includes an overlay data extractor (“1”) 722, an overlay data extractor (“2”) 724, and an overlay data extractor (“3”) 726, each of which is configured to identify a specific characteristic of the packets. For example, overlay data extractor 722, overlay data extractor 724, and overlay data extractor 726 can be configured to extract symbols the modified packet characteristics of packet length, header type, and checksum length, respectively. More or fewer modified packet characteristics can be demodulated, as well as other types of modified packet characteristics.

Further, overlay data extractors 722, 724, and 726 can be configured to acquire packet characteristic values from symbol inverse transform data 732, which provides for an inverse transformation of the transformed packets received into packet characteristic demodulator 746. Packet characteristic values in symbol inverse transform data 732 correspond to, or are associated with, a symbol. Overlay data extractors 722, 724, and 726 are configured to demodulate transformed packets as a function of the packet characteristic values (i.e., overlay data extractors 722, 724, and 726 can identify modified packet characteristics, and extract or otherwise decode the packet characteristics to obtain symbols therefrom.). In some examples, overlay data extractors 722, 724, and 726 are configured to demodulate characteristics of the packets by identifying, for example, packet lengths, header types, checksum lengths, or any other accessible characteristic of the packets. Therefore, overlay data extractors 722, 724, and 726 can decode the packet lengths, header types, and checksum lengths to form extracted symbols.

Data assembler 760 is configured to assemble a message that includes message data based on the extract symbols from the transformed packets received from device selector 744. In some examples, data assembler 760 can be configured to assemble a first portion of the symbols to establish a portion of the message that establishes a network connection with, for example, a server configured to stream media (e.g., a service, such as Spotify™ and the like). Further, data assembler 760 can be configured to assemble a second portion of the symbols to yield another message portion, whereby the second portion of symbols is configured to establish a communication path 763 between the receiving and transmitting devices. In this way, the transmitting device can receive confirmation of the receipt of its message data transmitted over the overlay communication channel. In some cases, extracted symbols can be stored as packet data 742 until such time that data assembler 760 can aggregate the extracted symbols to form message data, such as set forth in message data 770.

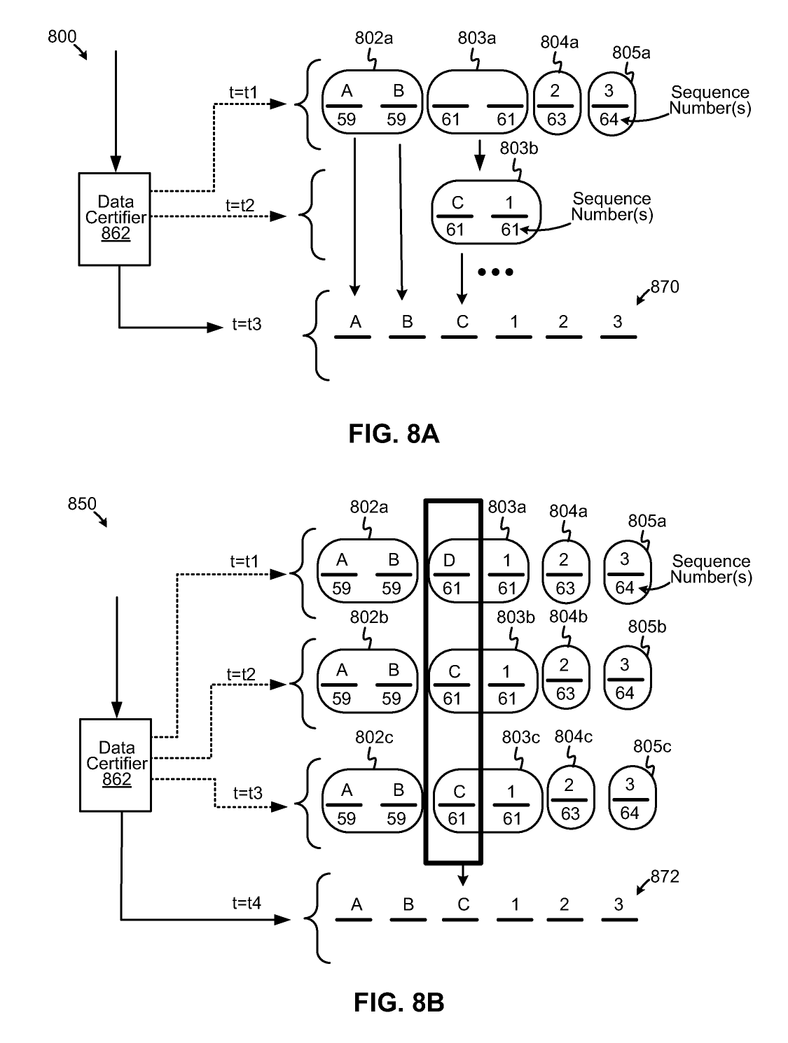

Data assembler 760 includes a data certifier 762, according to some embodiments. Data certifier 762 can be configured to certify that data received over an overlay communication channel is valid and/or correct, and can perform certain operations to correct missing or erroneous encoded symbol data, as is illustrated in FIGS. 8A and 8B. Message data 770 of FIG. 7 can be transmitted to a data processor (not shown), which can include a media processor or a communication processor. In one example, a media processor, responsive to message data, can transmit the message data to a third-party media streaming service to facilitate playback of audio or video content. In another example, a communications processor, responsive to message data 770, can generate an acknowledgment or confirmation message 788 for transmission via path 763 back to the transmitting device to confirm receipt of the transformed packets.

FIGS. 8A and 8B illustrate examples of perfecting message data received over an overlay communications channel, according to some examples. Diagram 800 of FIG. 8A depicts a data certifier 862 configured to identify and/or replace missing symbols. To illustrate its operation, consider that at time, t1, packets 802a, 804a, and 805a have been received by a data assembler. Data certifier 862 arranges these packets based on corresponding sequence numbers associated with those packets. Further, data certifier 862 is configured to detect that packet 803a is missing as there is no data associated with sequence number 61. In some case, data certifier 862 can request that the transmitting device repeat the transmission. Or, data certifier 862 can await for repeated transmissions from the originating device. At time, t2, packet 803b is received and has a sequence number of 61. Therefore, data certifier 862 can backfill the missing data from previous transmissions to form a completed message 870 at time, t3.

Diagram 850 of FIG. 8B depicts a data certifier 862 configured to correct symbol data. To illustrate its operation, consider that at time, t1, packets 802a, 803a, 804a, and 805a have been received by a data assembler, in an order specified by sequence numbers. Further, data certifier 862 can be configured to receive additional transmissions at time, t2, and at time, t3. At time, t2, packets 802b to 805b are received and at time, t3, packets 802c to 805c are received. But note that packets associated with sequence number 61 have different symbol values. Based on multiple instances of symbol “C” and only one instance of symbol “D,” data certifier 862 selects symbol “C” for insertion into message 872 at time, t4. Therefore, data certifier 862 can eliminate erroneous symbols, such as symbol “D.”

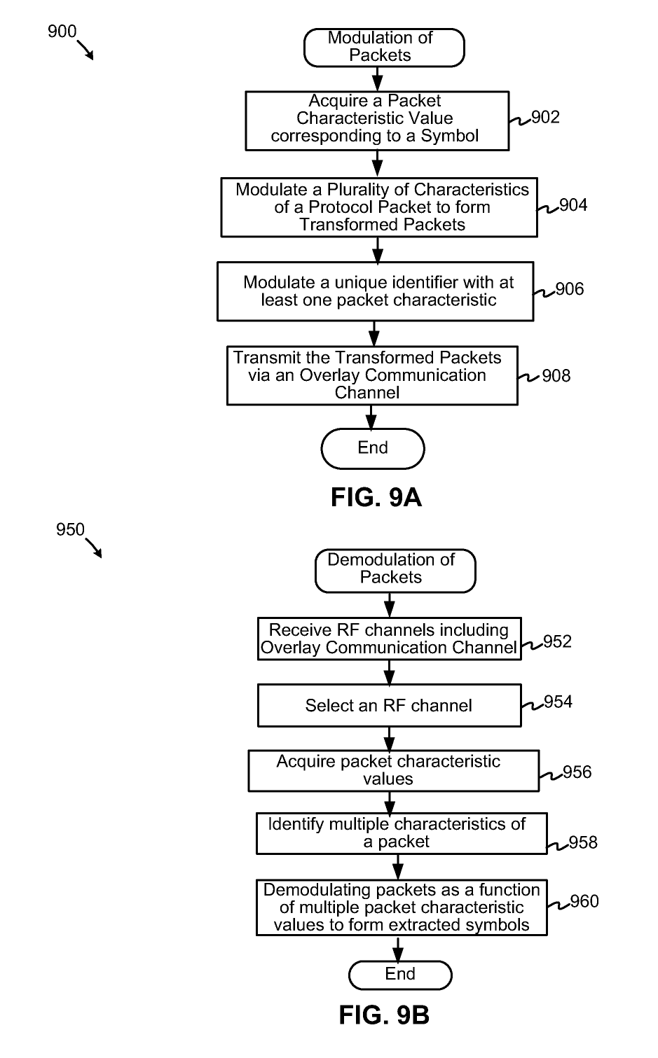

FIGS. 9A and 9B illustrate examples of modulating and demodulating multiple packet characteristics of packets and associated data, according to some embodiments. Flow 900 of FIG. 9A is an example flow for modulating multiple packet characteristics, according to some embodiments. Flow 900 can begin at 902 with acquiring ore packet characteristic values corresponding to one or more symbols. At 904, multiple packet characteristic are modulated to form transformed packets having compressed, encoded symbols. In some embodiments, the modulated packet characteristics are publicly accessible. In one example, packet characteristics that are modulated include the packet length of packets, a header type, and a checksum length. At 906, a unique identifier is modulated with at least one of packet. At 908, the transformed packets are transmitted via an overlay communication channel.

Flow 950 of FIG. 9B is an example flow of demodulating multiple packet characteristics, according to some embodiments. Flow 950 can begin at 952 with the reception of one or more RF channels, at least one of which includes an overlay communication channel. At 954, an RF channel is selected, and multiple packet characteristics are identified at 956. At 956, packet characteristic values are acquired, for example, from a repository, and at 958 multiple characteristics of a packet are identified. For example, packet length, header type, checksum length, or the like, can be identified as characteristics of the packets to which demodulation is applied. At 960, extracted symbols are formed by demodulating packets as a function of the multiple packet characteristic values.

In various embodiments, a mobile device including a packet characteristic modulator, such as a mobile phone or computing device, can be in communication (e.g., wired or wirelessly) with a media device including a packet characteristic demodulator. In some cases, such a mobile device, or any networked computing device (not shown) in communication with the media device, can provide at least some of the structures and/or functions of any of the features described herein. As depicted in FIG. 1A and subsequent figures (or preceding figures), the structures and/or functions of any of the above-described features can be implemented in software, hardware, firmware, circuitry, or any combination thereof. Note that the structures and constituent elements above, as well as their functionality, may be aggregated or combined with one or more other structures or elements. Alternatively, the elements and their functionality may be subdivided into constituent sub-elements, if any. As software, at least some of the above-described techniques may be implemented using various types of programming or formatting languages, frameworks, syntax, applications, protocols, objects, or techniques. For example, at least one of the elements depicted in FIG. 1A (or any figure) can represent one or more algorithms. Or, at least one of the elements can represent a portion of logic including a portion of hardware configured to provide constituent structures and/or functionalities.

For example, a packet characteristic demodulator (or modulator) and any of its one or more components, such as overlay data decompressor 720, overlay data extractors 722, 724, and 726, repository 730, repository 740, and data assembler 760 of FIG. 7 (or other FIGS.) can be implemented in one or more computing devices (i.e., any audio-producing device, such as desktop audio system (e.g., a Jambox® implementing LiveAudio® or a variant thereof), mobile computing device, such as a wearable device or mobile phone (whether worn or carried), that include one or more processors configured to execute one or more algorithms in memory. Thus, at least some of the elements in FIGS. 1A, 1B, 2, 3 and/or 5 (or any other figure) can represent one or more algorithms. Or, at least one of the elements can represent a portion of logic including a portion of hardware configured to provide constituent structures and/or functionalities. These can be varied and are not limited to the examples or descriptions provided.

As hardware and/or firmware, the above-described structures and techniques can be implemented using various types of programming or integrated circuit design languages, including hardware description languages, such as any register transfer language (“RTL”) configured to design field-programmable gate arrays (“FPGAs”), application-specific integrated circuits (“ASICs”), multi-chip modules, or any other type of integrated circuit. For example, packet characteristic demodulator (or modulator) and any of its one or more components, such as overlay data decompressor 720, overlay data extractors 722, 724, and 726, repository 730, repository 740, and data assembler 760 of FIG. 7 (or other FIGS.) can be implemented in one or more computing devices that include one or more circuits.

Thus, at least one of the elements in FIGS. 1A, 1B, 2, 3 and 7 (or any other figure) can represent one or more components of hardware. Or, at least one of the elements can represent a portion of logic including a portion of circuit configured to provide constituent structures and/or functionalities.

According to some embodiments, the term “circuit” can refer, for example, to any system including a number of components through which current flows to perform one or more functions, the components including discrete and complex components. Examples of discrete components include transistors, resistors, capacitors, inductors, diodes, and the like, and examples of complex components include memory, processors, analog circuits, digital circuits, and the like, including field-programmable gate arrays (“FPGAs”), application-specific integrated circuits (“ASICs”). Therefore, a circuit can include a system of electronic components and logic components (e.g., logic configured to execute instructions, such that a group of executable instructions of an algorithm, for example, and, thus, is a component of a circuit). According to some embodiments, the term “module” can refer, for example, to an algorithm or a portion thereof, and/or logic implemented in either hardware circuitry or software, or a combination thereof (i.e., a module can be implemented as a circuit). In some embodiments, algorithms and/or the memory in which the algorithms are stored are “components” of a circuit. Thus, the term “circuit” can also refer, for example, to a system of components, including algorithms. These can be varied and are not limited to the examples or descriptions provided.

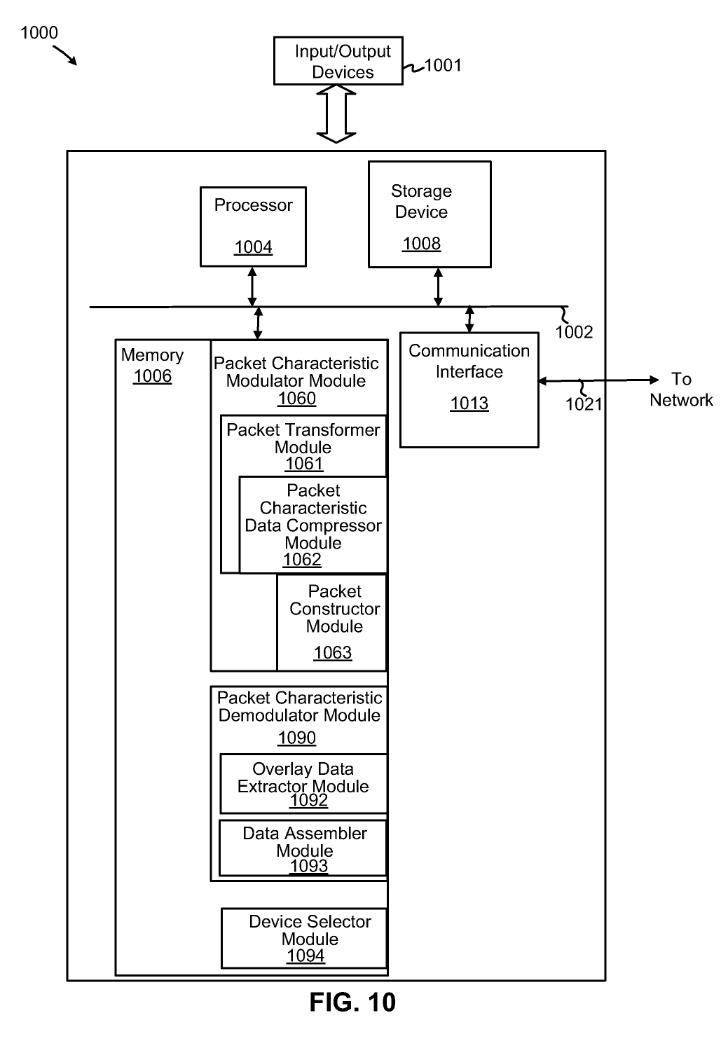

FIG. 10 illustrates an exemplary computing platform disposed in a media device, mobile device, or any computing device, according to various embodiments. In some examples, computing platform 1000 may be used to implement computer programs, applications, methods, processes, algorithms, or other software to perform the above-described techniques. Computing platform 1000 includes a bus 1002 or other communication mechanism for communicating information, which interconnects subsystems and devices, such as processor 1004, system memory 1006 (e.g., RAM, etc.), storage device 1008 (e.g., ROM, etc.), a communication interface 1013 (e.g., an Ethernet or wireless controller, a Bluetooth controller, etc.) to facilitate communications via a port on communication link 1021 to communicate, for example, with a computing device, including mobile computing and/or communication devices with processors. Processor 1004 can be implemented with one or more central processing units (“CPUs”), such as those manufactured by Intel® Corporation, or one or more virtual processors, as well as any combination of CPUs and virtual processors. Computing platform 1000 exchanges data representing inputs and outputs via input-and-output devices 1001, including, but not limited to, keyboards, mice, audio inputs (e.g., speech-to-text devices), user interfaces, displays, monitors, cursors, touch-sensitive displays, LCD or LED displays, and other I/O-related devices.

According to some examples, computing platform 1000 performs specific operations by processor 1004 executing one or more sequences of one or more instructions stored in system memory 1006, and computing platform 1000 can be implemented in a client-server arrangement, peer-to-peer arrangement, or as any mobile computing device, including smart phones and the like. Such instructions or data may be read into system memory 1006 from another computer readable medium, such as storage device 1008. In some examples, hard-wired circuitry may be used in place of or in combination with software instructions for implementation. Instructions may be embedded in software or firmware. The term “computer readable medium” refers to any tangible medium that participates in providing instructions to processor 1004 for execution. Such a medium may take many forms, including but not limited to, non-volatile media and volatile media. Non-volatile media includes, for example, optical or magnetic disks and the like. Volatile media includes dynamic memory, such as system memory 1006.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer can read. Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1002 for transmitting a computer data signal.

In some examples, execution of the sequences of instructions may be performed by computing platform 1000. According to some examples, computing platform 1000 can be coupled by communication link 1021 (e.g., a wired network, such as LAN, PSTN, or any wireless network) to any other processor to perform the sequence of instructions in coordination with (or asynchronous to) one another. Computing platform 1000 may transmit and receive messages, data, and instructions, including program code (e.g., application code) through communication link 1021 and communication interface 1013. Received program code may be executed by processor 1004 as it is received, and/or stored in memory 1006 or other non-volatile storage for later execution.

In the example shown, system memory 1006 can include various modules that include executable instructions to implement functionalities described herein. In the example shown, system memory 1006 (e.g., in a mobile computing device) can include a packet characteristic modulator module 1060 that includes a packet transformer module 1062, which includes a packet characteristic data compressor 1062, and a packet constructor module 1063. Alternatively, system memory 1006 (e.g., in a media device) can include a packet characteristic demodulator module 1090 including an overlay data decompressor module 1092 and a data assembler module 1093, and a device selector module 1094.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A method comprising:
receiving one or more radio frequency (“RF”) channels into a media device, at least one RF channel including an overlay communication channel over which packets convey message data modulated with characteristics of the packets;
selecting the at least one RF channel associated with a device from which the packets originate;
acquiring a subset of packet characteristic values to determine the message data, the packet characteristic values corresponding to one or more symbols;
demodulating at a processor the subset of the packet characteristic values to form extracted symbols; and
causing presentation of media in accordance with the message data.

2. The method of claim 1, further comprising:
determining a subset of the extracted symbols constitute an identifier associated with the device;
comparing the identifier to an address associated with the packets to form a match; and
selecting the device based on the match.

3. The method of claim 1, further comprising:
determining proximities of one or more devices associated with a subset of the one or more RF channels; and
selecting the at least one RF channel from the subset of the one or more RF channels based on a proximity of the device relative to the media device.

4. The method of claim 3, wherein determining the proximities of the one or more devices comprises:
determining RF signal strength values for the subset of the one or more RF channels; and
identifying a RF signal strength value associated with the at least one RF channel exceeds a threshold signal strength value.

5. The method of claim 4, wherein determining the determining RF signal strength values comprises:
analyzing values of a received signal strength indicator (“RSSI”).

6. The method of claim 3, wherein determining the proximities of the one or more devices comprises:
detecting one or more near field communication (“NFC”) signals that indicate the device is in a region adjacent to the media device.

7. The method of claim 1, further comprising:
prioritizing access of the device via the overlay communication channel to the media device higher than other devices.

8. The method of claim 1, wherein demodulating the subset of the packet characteristic values comprises:
extracting data representing two or more symbols modulated with a plurality of packet characteristic values of a packet.

9. The method of claim 8, wherein extracting the data modulated with the plurality of packet characteristic values comprises:
demodulating a first packet characteristic of the packet; and
demodulating a second packet characteristic of the packet.

10. The method of claim 9, wherein the first packet characteristic and the second packet characteristic are accessible.

11. The method of claim 9, wherein the first packet characteristic and the second packet characteristic comprise any two of a packet length, a packet header type, and a packet checksum length.

12. The method of claim 1, further comprising:
receiving packets unidirectionally from the device into the media device independent of authorization data that establishes permits connectivity between the device and the media device,
wherein the overlay communication channel facilitates autonomous discovery of the media device.

13. The method of claim 1, further comprising:
assembling the extracted symbols to form a message, assembling comprising:
receiving a repeated instance of the packets;
identifying a missing symbol;
inserting a symbol from the repeated instance of the packets to replace the missing symbol; and
eliminating an erroneous symbol.

14. The method of claim 1, wherein causing the presentation of the media comprises:
identifying a source of the media based on the message data; and
forming a network connection from the media device to the source of the media.

15. A method comprising:
receiving a signal to transmit transformed packets including message data via a radio transmitter to form an overlay communication channel, the message data specifying a network address as a source of data;
acquiring a first subset of packet characteristic values based on modulation of packet characteristics and symbols of the message data, at least one of the packet characteristic values corresponding to a symbol;
modulating at a processor a plurality of packet characteristics of a packet to form a transformed packet, the characteristics of packets specified as a function of a first packet protocol; and
transmitting the transformed packets via the overlay communication channel.

16. The method of claim 15, further comprising:
acquiring a second subset of packet characteristic values.
selecting a second packet protocol; and
modulating another plurality of packet characteristics as a function of the second packet protocol.

17. The method of claim 15, wherein receiving the signal comprises:
receiving data representing a user input from an interface of a mobile device to activate an application by the processor to initiate autonomous device discovery.

18. The method of claim 15, further comprising:
determining symbols constituting an identifier associated with a mobile device;
identifying packet characteristic values for the symbols; and
modulating at least one of the plurality of packet characteristics of the packet.

19. A system comprising:
a media device comprising:
a transceiver configured to receive multiple radio frequency (“RF”) communication signals from multiple devices, the multiple RF communication signals including packets;
a memory including a protocol stack including data representing communication protocol requirements;
a device selector configured to select at least one RF channel from the multiple RF communication signals based on a proximity of a device relative to the media device, the device being a source of a subset of the packets; and
a packet characteristic demodulator processor including:
a repository including packet characteristic values configured to determine message data from the subset of the packets, each of the packet characteristic values corresponding to a symbol;
an overlay data decompressor configured to acquire the packet characteristic values, to identify multiple characteristics of the subset of the packets specified by the protocol stack, and to extract multiple symbols from at least one packet in the subset of the packets to form extracted symbols;
a data assembler configured to assemble the extracted symbol to form an assembled message based on the extracted symbols; and
a data processor configured to perform an operation in accordance with the message.

20. The system of claim 19, further comprising:
a mobile device comprising:
a packet characteristic modulator processor including:
a packet transformer configured to transform the packets including the symbols into transformed packets, the packet transformer including:
a packet characteristic data compressor configured to modulate values of the multiple characteristics of the subset of the packets to encode the symbols into the transformed packets; and
a unique identifier (“ID”) manager configured to encode an identifier associated with the mobile device into at least one of the transformed packets; and
a packet constructor configured to construct the transformed packets in accordance with another protocol stack.
